(19) United States
(12) Patent Application Publication
(10) Pub. No.: US 2025/0297691 A1
(43) Pub. Date: Sep. 25, 2025

(54) VALVE CONTROL AND A METHOD FOR OPERATING A VALVE CONTROL

(71) Applicant: Festo SE & Co. KG, Esslingen (DE)

(72) Inventors: Andreas BÜHLER, Stuttgart (DE); Tobias WATZER, Deizisau (DE); Jens ENGELHARDT, Esslingen (DE)

(21) Appl. No.: 19/084,245

(22) Filed: Mar. 19, 2025

(30) Foreign Application Priority Data
Mar. 20, 2024 (DE) 10 2024 108 013.2

(51) Int. Cl. F16K 31/06; H02P 13/00

(52) U.S. Cl. CPC F16K 31/0675; H02P 13/00

(57) ABSTRACT

A valve control for the control of a solenoid coil of a solenoid valve, with a control device which includes a current measuring device for determining a coil current. The control device is designed to determine an electrical resistance of the solenoid coil and on the basis of the determined resistance to select at least one parameter from the group: pull-in current, pull-in time, holding current and holding time from a table of values which is stored in the control device, for a subsequent control of the solenoid coil and/or wherein the control device is designed to determine a parameter from the group: pull-in current, pull-in time, holding current and holding time. And a method for operating a valve control for the control of a solenoid coil of a solenoid valve.

### CROSS REFERENCE TO RELATED APPLICATION

The present application claims the benefit of German application DE 10 2024 108 013.2, filed Mar. 20, 2024, which is incorporated herein by reference.

### BACKGROUND OF THE INVENTION

The invention relates to a valve control for the control of a solenoid coil of a solenoid valve and to a method for operating a valve control.

A valve arrangement comprising at least one connection section for the connection of a valve unit which comprises a solenoid valve is known from DE 10 2019 203 574 A1, wherein the valve arrangement is designed to recognise the type of valve unit which is connected onto the connection section on the basis of an electrical variable which relates to the solenoid valve.

### SUMMARY OF THE INVENTION

The object of the invention is to provide a valve control for the control of a solenoid coil and a method for operating a valve control for the control a solenoid coil of a solenoid valve with an improved quality of the closed-loop control.

According to the invention, this object is achieved by a valve control for the control of a solenoid coil of a solenoid valve, with a control device which comprises a current measuring device for determining a coil current, wherein the control device is designed to determine an electrical resistance of the solenoid coil and on the basis of the determined resistance to select at least one parameter from the group: pull-in current, pull-in time, holding current and holding time from a table of values which is stored in the control device, for a subsequent control of the solenoid coil and/or wherein the control device is designed to determine a parameter from the group: pull-in current, pull-in time, holding current and holding time.

For an advantageous closed-loop control of the solenoid valve, it is necessary to take into account those parameters which characterise the solenoid coil in its interaction with further components of the solenoid valve. In particular, parameters such as a pull-in current, a pull-in time, a holding current and a holding time are counted as such. These parameters differ from solenoid valve to solenoid valve and can furthermore change during the operation of the solenoid coil. Since, for example in the case of a complex facility which comprises a multitude of solenoid valves, the unambiguous identification of each of the applied solenoid valves manually, for example by the user and their optimal control entail significant difficulties, parameters which function for a multitude of solenoid valves are often set for the applied valve controls, whereby this entails a reduced quality of the closed-loop control.

Basically, the solenoid valve to be controlled comprises a solenoid coil, a valve armature and a scaling element which is coupled in movement to the valve armature, and in particular can be designed as a poppet valve or as a slide valve. The sealing element is designed for the interaction with a valve seat which surrounds a valve opening of a fluid channel. The fluid channel extends in a valve housing of the solenoid valve between an inlet connection and an outlet connection.

The sealing element can be fixed to the valve armature in a direct manner and in this case a fluid which is subjected to pressure flows around it, said fluid being provided at the inlet connection and flowing to the outlet connection, inasmuch as the valve seat is not blocked by the scaling clement. Such a valve, in particular in the field of automation technology, can be applied as a pilot valve for a main valve which is arranged downstream and which is controlled by compressed air, or directly for the control of compressed air consumers, wherein in particular compressed air is applied as a fluid which is subjected to pressure. Alternatively, one can envisage an in particular rubber-elastic membrane being attached between the componentry of the solenoid valve and the valve armature, and the fluid channel with the valve seat. This membrane ensures a hermetic separation between the fluid channel and the componentry of the solenoid coil and the valve armature and is also denoted as a medium-separated solenoid valve. In particular, such solenoid valves are applied for the control of liquid flows which are subjected to pressure, for example in the field of laboratory technology, in particular for metering liquids.

In a deactivated state of the solenoid valve, the valve armature is situated in a deactivated end-position which is defined for example as a closure position, at which the sealing element which is coupled to the valve armature bears on the valve seat in a sealing manner, so that a fluid passage through the valve opening is blocked. In an activated state of the solenoid valve, the valve armature is situated in an activated end position which is denoted as the open position, wherein the sealing clement is distanced to the valve seat and the valve opening is released for a throughflow of fluid. A solenoid valve which is designed in such a manner is also denoted as a normally closed valve or NC-valve. Alternatively, one can envisage the solenoid valve releasing the valve seat in the deactivated state and closing the valve seat in the activated state, and a solenoid valve which is designed in such a manner is also denoted as a normally open valve or NO-valve.

In order to bring the valve armature into the activated end position starting from the deactivated end position, a coil current is provided to the solenoid coil by the control device, whereupon the solenoid coil forms an electromagnetic field which moves the valve armature into the activated end position. If the coil current is switched off, the valve armature is then to return again into the deactivated end position. For this, a valve spring which is arranged in the solenoid valve for this purpose can be provided, said valve spring being deformed given the movement of the valve armature from the deactivated end position into the activated end position and by way of this exerting a greater restoring force upon the valve armature in the activated end position than is the case in the deactivated end position.

The control device can be designed as a microprocessor, on which a program which reproduces the function of the control device is carried out. This program is stored on a memory which is connected to the microprocessor or which is integrated into the microprocessor.

For determining the coil current, the control device comprises a current measuring device which can either be designed as a separately (discretely) designed current measuring sensor or integrated into the control device in a direct manner. The current measuring device measures the current strength which is present at the solenoid coil, converts this current strength into a measurement value and makes this measurement value available to the program which runs in the control device, for further processing.

The pull-in current is that current strength which is necessary in order to move the valve armature from the deactivated end position into the activated end position by way of the electromagnetic field which is generated by the solenoid coil and thus in the case of an NC-valve to permit a fluid flow through the solenoid valve.

The pull-in current varies for differently designed solenoid valves which in particular comprise differently designed components from the group: solenoid coils, valve armatures, sealing elements. Furthermore, the pull-in current can change due to the heating-up of the solenoid coil on operation of the solenoid valve. If too low a current strength is provided for the solenoid coil, then the solenoid valve does not open or only to an incomplete extent.

The parameter pull-in time ta is the time which passes from the provision of the coil current until reaching the end position of the valve armature, thus until the valve armature has got from the deactivated end position into the activated end position. The movement of the valve armature presupposes at least the pull-in current being present and the solenoid coil being able to form a correspondingly high electromagnet filed. Consequently, the pull-in time results as the time period between a point in time at which the coil current is made available to the solenoid coil and a point in time at which the valve armature has reached the activated end position and the movement of the armature is herewith completed. In order to ensure a complete opening of the solenoid valve, on control of the solenoid coil the pull-in current must be provided at least for a time period which corresponds to the pull-in time of the solenoid valve which is connected to the valve control.

If the valve armature is situated in the activated end position, then a current strength which is lower compared to the pull-in current is sufficient in order to hold the valve armature in this position. This current strength is denoted as the holding current in the context of the present invention. The holding current should not be fallen short of, in order to ensure a reliable operation concerning which the solenoid valve does not close in an unintended manner. The holding current is lower than the pull-in current, so that given a reduction of the current which is present at the solenoid coil, from the pull-in current to the holding current, the solenoid coil of the solenoid valve is heated to a lesser extent and electrical energy can be saved.

The holding time in the context of the present invention is the time period over which the holding current is present at the solenoid coil. More precisely, the holding time results from the difference between a point in time at which the current which is present at the solenoid coil is reduced from the pull-in current to the holding current and a point in time at which the current which is present at the solenoid coil is reduced in order to achieve a movement of the valve armature from the activated end position into the deactivated end position and, given a design of the solenoid valve as an NC-valve, to block the fluid throughflow.

The aforementioned parameters are specific to the valve and/or specific to the solenoid coil which is applied in the solenoid valve. Therefore one envisages selecting these parameters according to the characteristics of the solenoid valve and taking then into account on control, for an optimised control of the solenoid valve.

In order to permit an optimised operation of different solenoid valves with the valve control, according to the invention one envisages the valve control automatically recognising the solenoid valve and in particular the solenoid coil of the connected solenoid valve and carrying out a parameter selection which is matched to the recognised solenoid coil.

A characteristic feature of a solenoid coil is its electrical resistance, so that the determining of this resistance permits an identification of the solenoid coil. Accordingly, one envisages the valve control carrying out a determining of the electrical resistance of the solenoid valve on starting operation, in order to indentify the solenoid coil of the connected solenoid valve. After the identification of the solenoid coil, the control device selects at least one parameter from the group: pull-in current, pull-in time, holding current, holding time, from a table of values which is stored in the control device, for the subsequent control of the solenoid coil. The table of values can herein be stored as a file in the memory of the control device or be stored in the control device in an equivalent manner.

On using the valve control with a solenoid valve whose parameters from the group: pull-in current, pull-in time, holding current and holding time are not stored in the table of values and/or if on determining the electrical resistance of the solenoid coil this cannot be indentified or is not known to the valve control, the valve control according to the invention can determine a parameter from the group: pull-in current, pull-in time, holding current and holding time. Thus for example it is possible for the valve control to be connected by signal technology to a throughput meter which measures a throughflow through the solenoid valve which is connected to the valve control. If, given this measurement, the measured throughflow corresponds to the maximal throughflow of the connected solenoid valve, then the valve armature is situated in the open position, so that the time period between no throughflow and the maximal throughflow is a measure for the pull-in time, wherein the time period can be corrected by any delay time which is caused by the inertia of the fluidic system, by the control device.

Advantageous further developments of the invention are the subject-matter of the dependent claims.

Preferably, for determining the pull-in current, the control device is designed to provide the solenoid coil with a continuously increasing coil current and to determine the pull-in current by way of determining a first direction change, in particular a current drop, in the measured coil current, said change characterising a valve movement.

In the context of the present application, herein what is meant by a continuously increasing coil current is a coil current which increases over an observation time period independently of whether the increase is continuous or step-like, as for example in the case of a digital signal. As already described, given a coil current which corresponds at least to the pull-in current, the solenoid coil of the solenoid valve forms an electromagnetic field which is sufficient to cause a movement of the valve armature. Given the movement of the valve armature out of the deactivated end position into the activated end position, the measured coil current drops as a result of the movement uptake of the valve armature, since a mutual inductance occurs in the solenoid coil due to the movement uptake, and this mutual inductance is counter to the coil current. Accordingly, due to the movement of the valve armature which can also be denoted as a valve movement, a direction change in the course of the curve for the measured coil current occurs, wherein the current strength at which this direction change sets in corresponds to the pull-in current of the solenoid coil. Accordingly, the pull-in current of the solenoid valve which is connected to the control device can be determined by way of the measurement of the coil current. This determined pull-in current can be stored in the control device for subsequent control procedures, so that in the case of the solenoid valve not being able to be identified by way of the determined pull-in current, this pull-in current can be used for a closed-loop control of the solenoid valve given a further switching procedure.

Given a use of the determined pull-in current for subsequent switch-on procedures for the solenoid valve, one prevents the solenoid coil of the solenoid valve from being subjected to an unnecessarily high coil current which could lead to an undesirable heating-up of the solenoid coil. In order to prevent errors on determining the pull-in current, a suitable signal filtering, for example of the measured coil current and/or of the signal which corresponds to the measured coil current can preferably be carried out in the control device, in particular a smoothing of the signal in order to reduce influences of signal noise. The measured coil current is preferably converted into a digital signal by way of an analog-to-digital converter which is integrated in the control device or in the current sensor.

Given a further development of the invention, for determining the pull-in time, one envisages the control device being designed to determine a further direction change which characterises an end of the valve movement, in the measured coil current and to determine the pull-in time from the temporal difference between the provision of the coil current and the further direction change of the measured coil current. If the movement of the valve armature ends on reaching the activated end position, then the measured coil current increases again until it reaches a designated maximal current strength. This is due to the fact that on reaching the activated end position, no further relative movement of the valve armature with respect to the solenoid coil and herewith also no further mutual inductance is present. Herewith, a renewed direction change in the measured coil current occurs after the end of the movement of the valve armature, said direction change characterising the end of the movement of the valve armature, thus the end of the valve movement. The pull-in time can therefore be determined from the difference between a point in time at which the coil current is provided and a point in time at which the movement of the valve armature ends.

With the knowledge of the pull-in time, given subsequent switching procedures it can be ensured for the solenoid valve that the current which is necessary for the valve movement is provided over an adequately long period of time which corresponds at least to the pull-in time, in order to permit an error-free operation of the solenoid valve. Simultaneously, one can ensure that the pull-in current is not provided over an unnecessarily long time period and thus energy being unnecessarily consumed and the solenoid coil not being unnecessarily heated.

Further preferably, for determining the holding current, the control device is designed to continuously reduce the coil current which is provided to the solenoid coil and to determine the holding current by way of determining a direction change, in particular an increase, in the measured coil current, said change characterising a valve movement. Given the continuous reduction of the coil current which is provided to the solenoid coil of the solenoid valve, a reduction of the magnetic forces which act upon the valve armature from the solenoid coil is effected, so that this valve armature for example is moved out of the activated end position due to the restoring force of the restoring spring. Described in other words, the holding current which is necessary for maintaining the activated end position is fallen short of at a certain point in time and a valve movement, i.e. a movement of the valve armature occurs. Due to the movement of the valve armature by way of the electromagnetic field of the solenoid coil, an increase in the measured coil current occurs as a result of the mutual inductance which this movement entails. This direction change in the measured coil current serves as an indicator for the valve movement. The measured coil current which is present when the movement of the valve armature sets in corresponds to the holding current of the solenoid valve which is connected to the valve control. Accordingly, the valve control can determine the holding current which is necessary for the connected solenoid valve and take it into account for the solenoid valve given a subsequent switching procedure. Preferably, the control device is configured to increase the determined holding current by a predefined amount and to provide this increased holding current to the solenoid coil as soon as the valve armature has reached the activated end position. It is therefore rendered possible for a significantly high holding current to be provided and a reliable operation of the valve is made possible and at the same time no unnecessarily high holding current needs to be provided.

Advantageously, the control device is designed to store a parameter from the group: pull-in current, pull-in time, holding current and holding time in the table of values in the control device and/or to update it in the table of values which is stored in the control device. Thus for example the values of a firstly unknown solenoid valve can be stored in the control device in order to provide them for the further operation without the determining of the individual parameters having to be carried out afresh before each switching procedure. It is also made possible for parameters whose value changes as a result of the operation of the solenoid valve to be updated, in order to provide these for a further operation.

Preferably, the control device is designed to increase one of the determined parameters from the group: pull-in current, pull-in time, holding current and holding time by a suitable safety factor before the storing and/or the updating in the table of values. In order to further improve the operational reliability and to ensure a correct manner of functioning of the solenoid valve, the control device can increase the determined parameters for example by 10% or by another percentage amount, in order for example to counteract a change of the solenoid coil over the application duration and/or a heating of the solenoid coil and/or operational influences such as vibrations.

In an advantageous embodiment of the valve control, the control device comprises at least one controller, in particular PID-controller, wherein a closed-loop control behaviour of the controller is adapted in dependence on at least one parameter from the group; pull-in current, pull-in time, holding current and holding time and/or in dependence on the determined electrical resistance of the solenoid coil. Herein, the aforementioned parameters and/or the electrical resistance of the solenoid coil are used in particular for the selection of a P-component, an I-component, a D-component, a reset time and/or a derivative time of the controller. Thus for example it is rendered possible for the coil current which is provided to the solenoid coil to also be kept constant given a heating of the solenoid coil and an electrical resistance of the solenoid coil which is changed due to this, by way of an adaptation of the controller. The further parameters can also be used for the setting of the controller or are present by way of the evaluation by the control device, for the closed-loop control, even given a previously unknown solenoid valve.

In a preferred embodiment of the valve control device, the control device is designed to determine the electrical resistance of the solenoid coil by way of a switching signal which is sent to the solenoid valve. For this, a resistance measurement can be activated by the switching signal or a signal component of the switching signal can be used itself for determining the electrical resistance of the solenoid coil, wherein a temporal shift between the switching signal and the movement of the valve armature is caused. Accordingly, the electrical resistance of the solenoid coil can be determined in a recurring manner over the application duration of the solenoid valve, and a temporal change, in particular as a result of the heating of a solenoid coil can be taken into account for the closed-loop control.

The previously defined object is also achieved by a method for operating a valve control for the control of a solenoid coil of a solenoid valve. The method comprises the steps: determining an electrical resistance of the solenoid coil of the solenoid valve connected to the valve control by way of a switching signal which is sent to the solenoid valve, selecting at least one parameter from the group: pull-in current, pull-in time, holding current and holding time on the basis of the determined resistance from a table of values which is stored in the control device, for a subsequent control of the solenoid valve and/or determining a parameter from the group: pull-in current, pull-in time, holding current and holding time of the solenoid valve.

Concerning a further development of the method for operating a valve control with a control device for the control of a solenoid coil of a solenoid valve, this method further comprises the steps: providing a continuously increasing coil current, measuring the continuously increasing coil current, determining a pull-in current by way of determining a direction change of the measured coil current which characterises a valve movement and/or providing a continuously decreasing coil current, measuring the decreasing coil current and determining a pull-in current by way of determining a direction change of the decreasing coil current which characterises a valve movement.

In a further embodiment, the method for operating a valve control for the control of a solenoid coil of a solenoid valve further comprises: determining a further direction change of the measured coil current which characterises an end of the valve movement and determining a pull-in time from the temporal difference between the provision of the first coil current and the further direction change of the measured coil current.

The method for operating a valve control for the control of a solenoid coil of a solenoid valve preferably further comprises the adapting of a closed-loop control behaviour of a controller of the control in dependence on a selected and/or defined parameter from the group: pull-in current, pull-in time, holding current and holding time.

### BRIEF DESCRIPTION OF THE DRAWINGS

The invention is hereinafter explained in more detail by way of the accompanying drawings and in these are shown:

FIG. 1 a strictly schematic representation of a valve arrangement and a valve control which is connected to the valve arrangement,

FIG. 2 a strictly schematic representation of a solenoid valve of the valve arrangement of FIG. 1,

FIG. 3 a strictly schematic representation of a course of a measured coil current and a switching signal during a switching procedure of a solenoid valve,

FIG. 4 a strictly schematic representation of a determining of a pull-in current and holding current and

FIG. 5 a strictly schematic representation of a course of the determined electrical resistance, of a switching signal and of a movement of a valve armature.

### DETAILED DESCRIPTION

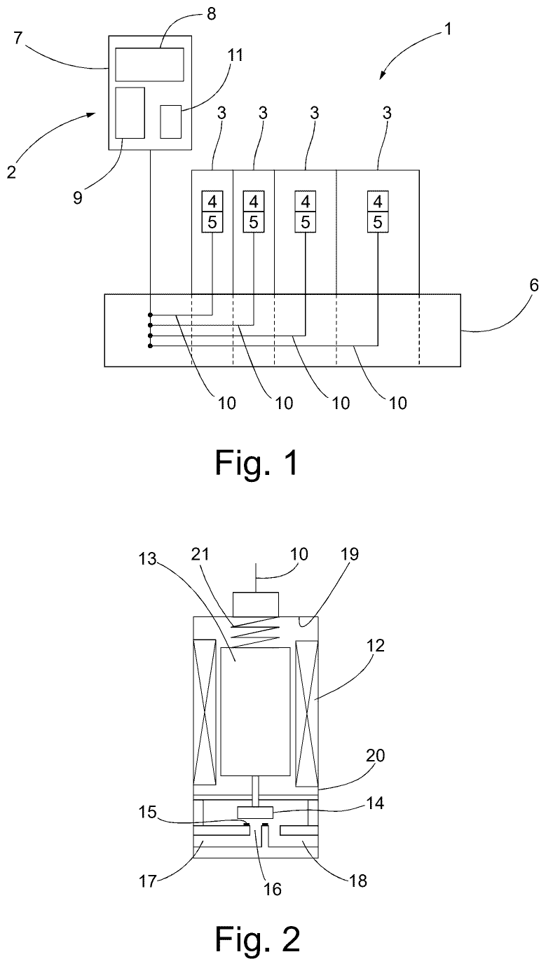

A valve arrangement 1 and a valve control 2 which is connected to the valve arrangement 1 by signal technology is shown in FIG. 1. The valve arrangement 1 purely by way of example as a whole comprises four valve units 3 which are designed in a disc-like manner and which are rowed along a row direction in a manner such that one side of the valve unit 3 is in contact with at least one side of a further valve unit 3. Expediently, each valve unit 3 comprises at least one solenoid valve 4 as well as a main valve 5, concerning which it is expediently a fluidically actuatable valve. The solenoid valve 4 serves for controlling the provision of a fluid, via which a valve element (not shown) of the main valve 5 is actuated. The solenoid valve 4 can accordingly also be denoted as a pilot valve. For a coupling of the valve units 3 onto the valve arrangement 1, the valve arrangement 1 comprises a connection section 6, into which the valve units 3 for example can be inserted, wherein in particular one envisages individual valve units 3 being exchangeable by other valve units 3 for different configurations of the valve arrangement 1.

The valve control 2 comprises a control device 7 with a controller 8 and a current sensor 9 and is connected to each valve unit 3 via control leads and signal technology. Purely by way of example, in FIG. 1 the control device 7 is accommodated in a separate housing, in particular a housing which is designed as a connection plug, and is designed as a microcontroller which comprises a programmable memory 11. However, it is also conceivable for the control device 7 to be integrated in a superordinate control and to be connected to the controller 8 and/or to the current sensor 9 by signal technology, inasmuch as these are not also integrated in the superordinate control.

A solenoid valve 4 of an arbitrary valve unit 3 of FIG. 1 is represented in FIG. 2 in a strictly schematic manner. Purely by way of example, the solenoid valve 4 is designed as a 2/2-way valve and comprises a solenoid coil 12, a valve armature 13, a valve element 14 which is coupled in movement to the valve armature 13, as well as a valve opening 16 which is surrounded by a valve seat 15 and which fluidically connects a valve inlet 17 to a valve outlet 18. The solenoid valve 4 is represented in an activated state in which the valve armature 13 is situated in an open position, in which the valve element 14 is lifted from the valve seat 15 and thus releases the valve opening 16 for a fluid passage, so that a fluid can flow from the valve inlet 17 to the valve outlet 18. In a deactivated state of the solenoid valve 4 which is not shown, the valve armature 13 is situated in a closure position in which the valve element 14 bears on the valve seat 15 and herewith blocks the valve opening 16 for a fluid passage. A valve spring 21 is arranged between the housing wall 19 of the solenoid valve housing 20 and the valve armature 13, in order to provide an adequately high scaling force and in order to move the valve armature 13 out of the open position into the closure position.

The activated state of the solenoid valve 4 or the open position of the valve armature 13, which is represented in FIG. 2 is reached from the deactivated state or the closure position when an adequately high current strength which can also be denoted as a pull-in current Ia is provided to the solenoid coil 12 during a switching procedure by way of the control device 7 and the solenoid coil 12 forms a corresponding electromagnetic field, so that the valve armature 13 is moved from the closure position into the open position. If the valve armature 13 is situated in the open position, then the control device 7 can reduce the current which is made available to the solenoid coil 12 to a current strength at which the strength of the electromagnetic field which is formed by the solenoid coil 4 is sufficient in order to hold the valve armature 13 in the open position counter to the spring action or restoring force of the valve spring 21. This current strength can also be denoted as the holding current Ih. A change from the deactivated state into the activated state and in the opposite direction, i.e. from the activated state into the deactivated state can herein be denoted as a switching procedure.

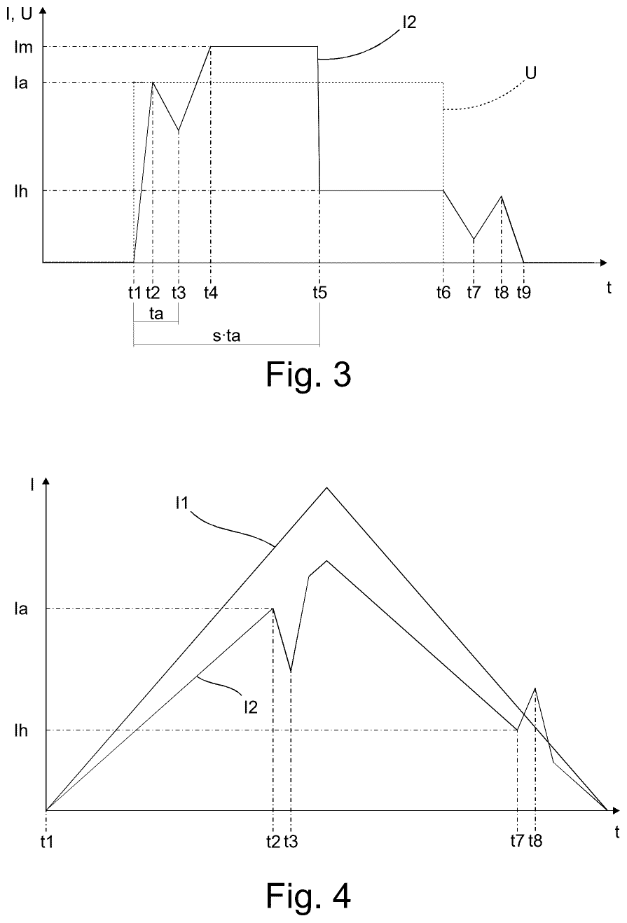

FIG. 3 shows a strictly schematic representation of a course of a measured coil current I2 and a switching signal U during an exemplary switching procedure of the solenoid valve 4. The represented courses, in particular any relations, are drawn in a greatly exaggerated manner for the purpose of an improved overview. On starting operation, the control device 7 carries out a determining of an electrical resistance W of the solenoid valve 4, in order to identify the solenoid valve 4 which is connected to the control device 7. If herein the solenoid valve 4 is identified as a solenoid valve 4 which is known to the control device 7, then the control device 7 retrieves the parameters pull-in current Ia, pull-in time ta, holding current Ih and holding time th from a table of values which is stored in the memory 11, in order to take these into account given the closed-loop control of the connected solenoid valve 4. The control device 7 receives the switching signal U at a point in time t1, whereupon the control device 7 provides the solenoid coil 12 with a coil current I1 via the control lead 10, wherein this is a maximal coil current Im which corresponds to the pull-in current Ia increased by a safety factor.

The measured coil current I2 increases linearly between the point in time t1 and a point in time t2, until at the point in time t2 it reaches the current strength which corresponds to the pull-in current Ia. At this point in time t2, the strength of the arising electromagnetic field is sufficient in order to initiate the movement of the valve armature 13 out of the closure position counter to any holding forces between the valve element 13 and the valve seat 15 as well as to a restoring force of the valve spring 21. An induction in the solenoid coil 12 is caused due to the movement of the valve armature 13 in the solenoid coil 12, as a result of which induction a drop in current and herewith a first direction change in the measured coil current I2 occurs. If the movement of the valve armature is completed at the point in time t3, then the measured coil current I2 increases up to the maximal coil current Im which is provided by the control device 7. The maximal coil current Im herein corresponds to the pull-in current Ia which was increased by a safety factor by the control device 7. The further direction change in the measured coil current I2 accordingly characterises an end of the movement of the valve armature 13. The movement of the valve armature 13 takes place between the points in time t2 and t3. The difference between t1 and t3 corresponds to the pull-in time ta of the solenoid valve 4.

At the point in time t5, the control device 7 reduces the current which is made available to the solenoid coil 12 to the holding current Ih which is selected for the solenoid valve 4, wherein the temporal difference between the point in time t1 and the point in time t5 corresponds to the pull-in time ta which is increased by a safety factor s. The holding current Ih which is shown in FIG. 3 likewise corresponds to a holding current increased by a safety factor. At the end of the switching signal U at the point in time t6, the control device 7 no longer provides a coil current I to the solenoid coil 12 and the measured coil current 12 reduces. The difference between the points in time t5 and t6 herein corresponds to the previously selected holding time th. The coil current I2 at the point in time t7 herein falls short of the necessary holding current Ih, whereupon the movement of the valve armature 13 from the open position into the closure position sets in. By way of the movement of the valve armature 13 between the solenoid coil 12, an induction in the solenoid coil 12 is again created, by which means an increase in the measured coil current I2 occurs. If the movement of the valve armature 13 is completed after reaching the closure position at the point in time t8, then the measured coil current I2 drops again, until finally at the point in time t9 no coil current is present any longer at the solenoid coil 12 and the switching procedure is completely finished.

Strictly schematic courses of a provided coil current I1 and of a measured coil current I2 for determining the parameters pull-in current Ia, pull-in time ta and holding current Ih are represented in FIG. 4. The shown courses, in particular any relations are drawn in a greatly exaggerated manner for a better overview, as well as smoothed, and the provided coil current I1 and the measured coil current I2 are accordingly scaled. The method is then preferably carried out by the valve control 2 when the solenoid valve 4 cannot be identified on determining the electrical resistance W of the solenoid valve 4 connected to the control device 2. In particular, this is the case when the valve control 2 is connected to the solenoid valve 4 for the first time or its resistance has greatly changed as a result of a long operation or a heating-up. In order to determine the aforementioned parameters, the control device 7 provides the solenoid coil 12 with a continuously increasing coil current I1. Thereupon, the measured coil current I2 increases up to a point in time t2 at which the movement of the valve armature 13 from the closure position into the open position begins. The coil current I2 which is measured at this point in time t2 corresponds to the pull-in current Ia of the solenoid valve 4 which is connected to the valve control 2. The value of the pull-in current Ia is received by the control device 7 and is stored for this solenoid valve 4 in the memory 11 of the control device 7.

If the movement of the valve armature 13 ends at the point in time t3, then the measured coil current I2 increases again in order to follow the provided coil current I1. The control device 7 determines the pull-in time ta from the difference between the points in time t1 and t3 and likewise stores this in the memory 11 for a later use. After the pull-in current Ia and the pull-in time ta have been determined, the control device 7 continuously lowers the provided coil current I1, whereupon the measured coil current I2 also reduces. At the point in time t7 the measured coil current I2 falls short of the holding current Ih which is characteristic of the solenoid valve 4 which is connected to the valve control 2, whereupon the movement of the valve armature 13 out of the open position back into the closure exposition sets in and the measured coil current I2 rises. The rise in the coil current I2 ends at the point in time t8 at which the valve armature 13 has reached the closure position and has herewith ended its movement. The holding current Ih is likewise stored in the memory 11 for a later use. Preferably, the method which has just been described is repeated several times, for example five times, in order to eliminate any interfering influences in the determined parameters via an averaging, or to reduce their influence.

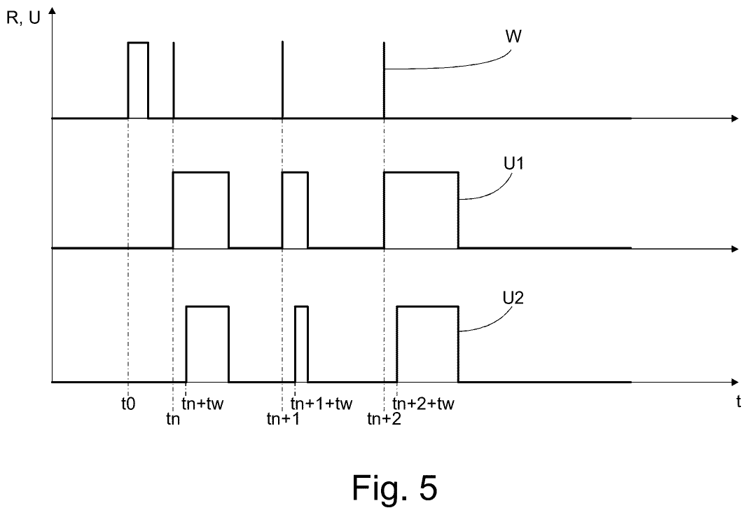

A course of a determined electrical resistance W of the solenoid coil 12, of a switching signal U1 which is sent to the control device 7 and of the movement U2 of the valve armature 13 is shown in FIG. 5 in a strictly schematic manner. The control device 7 firstly determines the electrical resistance W of the solenoid coil 12 at the point in time t0, in order to indentify the solenoid valve 4. A switching signal U1 is subsequently provided at each of the points in time tn, tn+1 and tn+2, wherein a first signal component is used for the determining of the electrical resistance of the solenoid coil 12, as is to be recognised at the represented peaks in the course of the electrical resistance W. It is not until after this determining of the resistance that the movement of the valve armature begins at the points in time tn+tw, tn+1+tw and tn+2+tw, wherein tw represents the temporal delay between the provision of the switching signal U1 and the onset of the movement of the valve armature 13 and hence the duration of the determining of the electrical resistance W of the solenoid coil 12. Accordingly, the electrical resistance W of the solenoid coil 12 can be determined during the operation of the valve control 2 without for this the operation having to be interrupted or a separate signal sent to the control device 7.

1. A valve control for the control of a solenoid coil of a solenoid valve, with a control device which comprises a current measuring device for determining a coil current, wherein the control device is designed to determine an electrical resistance of the solenoid coil and on the basis of the determined resistance to select at least one parameter from the group: pull-in current, pull-in time, holding current and holding time from a table of values which is stored in the control device, for a subsequent control of the solenoid coil and/or wherein the control device is designed to determine a parameter from the group: pull-in current, pull-in time, holding current and holding time.

2. The valve control according to claim 1, wherein for determining the pull-in current, the control device is designed to provide the solenoid coil with a continuously increasing coil current I2 and to determine the pull-in current Ia by way of determining a first direction change, in particular a current drop, in the measured coil current I2, said first direction change characterising a valve movement.

3. The valve control according to claim 2, wherein for determining a pull-in time ta, the control device is designed to determine a further direction change which characterises an end of the valve movement, in the measured coil current I2 and to determine the pull-in time ta from the temporal difference between the provision of the coil current I1 and the further direction change of the measured coil current I2.

4. The valve control according to claim 1, wherein for determining the holding current, the control device is designed to continuously reduce the coil current I1 which is provided to the solenoid coil and to determine the holding current Ih by way of determining a direction change, in particular an increase, in the measured coil current I2, said direction change characterising a valve movement.

5. The valve control according to claim 1, wherein the control device is designed to store a parameter from the group: pull-in current, pull-in time, holding current and holding time in the table of values in the control device and/or to update it in the table of values which is stored in the control device.

6. The valve control according to claim 5, wherein the control device is designed to increase one of the determined parameters from the group: pull-in current, pull-in time, holding current and holding time by a suitable safety factor before the storing and/or the updating in the table of values.

7. The valve control according to claim 1, wherein the control device comprises at least one controller, in particular PID-controller, wherein a closed-loop control behaviour of the controller is adapted in dependence on at least one parameter from the group; pull-in current, pull-in time, holding current and holding time and/or in dependence on the determined electrical resistance of the solenoid coil.

8. The valve control according to claim 1, wherein the control device is designed to determine the electrical resistance of the solenoid coil by way of a switching signal which is sent to the solenoid valve.

9. A method for operating a valve control for the control of a solenoid coil of a solenoid valve, comprising the steps: determining an electrical resistance of the solenoid coil of the solenoid valve connected to the valve control, by way of a switching signal which is sent to the solenoid valve and selecting at least one parameter from the group: pull-in current, pull-in time, holding current and holding time on the basis of the determined resistance from a table of values which is stored in the control device, for a subsequent control of the solenoid valve and/or determining a parameter from the group: pull-in current, pull-in time, holding current and holding time of the solenoid valve.

10. The method for operating a valve control with a control device for the control of a solenoid coil of a solenoid valve according to claim 9, further comprising: providing a continuously increasing coil current I1, measuring the continuously increasing coil current I2, determining a pull-in current Ia by way of determining a direction change of the measured coil current I2 which characterises a valve movement and/or providing a continuously decreasing coil current I1, measuring the decreasing coil current I2 and determining a pull-in current Ia by way of determining a direction change of the decreasing coil current I2 which characterises a valve movement.

11. The method for operating a valve control for the control of a solenoid coil of a solenoid valve according to claim 10, further comprising: determining a further direction change of the measured coil current I2 which characterises an end of the valve movement and determining a pull-in time ta from the temporal difference between the provision of the first coil current I1 and the further direction change of the measured coil current I2.

12. The method for operating a valve control for the control of a solenoid coil of a solenoid valve according to claim 9, further comprising: adapting a closed-loop control behaviour of a controller of the control device in dependence on a selected and/or defined parameter from the group: pull-in current, pull-in time, holding current and holding time.
